(19) United States
(12) Patent Application Publication
(10) Pub. No.: US 2002/0082920 A1
(43) Pub. Date: Jun. 27, 2002

(54) System and methods for providing a multi-merchant loyalty program

(76) Inventors: Kermit Austin, Tucson, AZ (US); Don Mastrangelo, Tucson, AZ (US)

Correspondence Address: Kermit Austin, 1710 E. Speedway Blvd., Tucson, AZ, 85719, US

(21) Appl. No.: 10/008,712

(22) Filed: Nov. 13, 2001

Related U.S. Application Data
(60) Provisional application No. 60/249,259, filed on Nov. 17, 2000.

(51) Int. Cl. G06F 17/60

(52) U.S. Cl. 705/14

(57) ABSTRACT

The invention provides a loyalty system for awarding incentives to a customer based on a multi-merchant loyalty system. The loyalty system includes a master loyalty program associated with the multi-merchant loyalty system, at least one merchant specific loyalty program associated with the multi-merchant loyalty system, a means for providing a merchant access to the multi-merchant loyalty system, and a means for providing a customer choice of an incentive. In addition, the invention provides a method for promoting merchant loyalty. The method defines a master loyalty program for a multi-merchant loyalty system, registers a merchant specific loyalty program for the multi-merchant loyalty system, and provides a merchant access to the multi-merchant loyalty system.

### RELATED APPLICATION AND CLAIM OF PRIORITY

This application claims priority from U.S. Provisional Application No. 60/249,259 by Mastrangelo, et al., entitled METHOD AND SYSTEM FOR PROVIDING A MULTI-MERCHANT LOYALTY PROGRAM, which was filed on Nov. 17, 2000.

### BACKGROUND

### FIELD OF THE INVENTION

The invention relates to customer loyalty programs, and more particularly, the invention relates to customer loyalty programs having multiple merchant participants.

Statement of a Problem Addressed by the Invention

Merchants often maintain customers, increase customer loyalty, and increase customer purchases by offering incentive programs. However, it is a principle of economics that when customers are offered the same product at two different prices, they will always choose the lower price. Accordingly, customers tend to be “loyal” to the merchant who offers the lowest price—for example, witness the rise of discount chain stores.

Loyalty programs come in a variety of forms. Some loyalty programs use coupons for future purchases, while some loyalty programs use discounts on current purchases. Often, incentives include discounts (a % off), certificates/coupons ($1 off). In addition to monetary incentives, sometimes non-monetary incentives are offered. For example, a loyalty program may provide better seats, free food, or merchandise.

Often, customers who participate in a loyalty program have higher average transaction amounts than those customers who do not participate in a loyalty program. In addition, customers in loyalty programs are more likely to refer other customers to the merchant who sponsors the loyalty program, especially if the customers has a quasi-financial interest in the promotion of that merchant, and if the customer has received benefits from the loyalty program in the past.

Unfortunately, the setup cost of a loyalty program is prohibitively high to all but the largest of merchants. In addition, the costs of maintaining an incentives program can be quite burdensome. Furthermore, if mismanaged, a merchant could be saddled with a large liability account that could make a balance sheet look poor. Accordingly, small merchants often conclude that a loyalty program is not an efficient way to attract and retain customers.

Another disadvantage of loyalty programs is that they are merchant specific. Often, a customer will not visit a merchant often enough to make it worth the time and hassle of keeping a club card in a wallet or purse. In addition, even if the incentive is available absent the club card, a customer will not likely visit the merchant because of the loyalty program absent some tangible reminder of the incentive program. Thus, for many customers, tracking several loyalty programs is too burdensome and overbearing to warrant actively participating in the incentive program.

Selected Discussion of a Selected Embodiment

The invention provides technical and business advantages as a system and method of implementing a loyalty program. The loyalty program includes a master loyalty system that enables a participating merchant to create, implement, and/or manage an incentive program. In a preferred embodiment, the loyalty program is customizable. In one embodiment, incentives may be offered to customers at the program level and at the merchant level, thus allowing a merchant to choose to participate in a larger program, or to maintain a “local” loyalty program. Because a large number of merchants may participate in the loyalty program, a customer may only need to carry one identification means, or memorize one piece of identification information.

Accordingly, the invention provides general program incentives, or merchant-specific incentives, to customers via a multi-merchant loyalty program. A customer, who may or may not have an identification card or other identification means, can receive incentives from a plurality of merchants, may pool points from a plurality of merchants, and may then move points from the pool to any particular merchant incentive. Likewise, a merchant may easily join the loyalty program at a variety of participatory levels.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1A is a diagram of a multi-merchant loyalty system;

FIG. 1B illustrates another embodiment of a multi-merchant loyalty system;

FIG. 2 shows a diagram of a merchant loyalty program for a multi-merchant loyalty system;

FIG. 3 provides a diagram of an incentive parameters module;

FIG. 4 illustrates a track/customer data module;

FIG. 5 shows a customer module;

FIG. 6 is a flowchart of selected acts of an activation process;

FIG. 7 shows an exemplary receipt; and

FIG. 8 provides an alternative receipt.

### EXEMPLARY EMBODIMENT OF A BEST MODE

Introduction

The invention is a loyalty system that embraces multiple merchant participants. For each transaction, such as a purchase, a user earns points. The points may be applied to a master loyalty program, a merchant specific loyalty program, or both. Then, once a predetermined number of points are accumulated, then the loyalty system may provide incentives to a customer (or any user designated by the customer) from either the master loyalty program, or a merchant specific loyalty program. In addition, merchants may use the data collected via the loyalty system to provide additional incentives, or to target customers with specific advertising or promotions.

In one embodiment, the invention is implemented as an identification means such as a loyalty card or other tangible object. In a preferred embodiment, the identification means is one or more customer-preferred methods of payment, such as a credit card or debit card. Thus, when the customer presents the identification means for a transaction, then the transaction results in points being earned in the merchant's loyalty system, the master loyalty system, or both. In one embodiment, a predetermined number of points are provided for each currency unit (U.S. Dollar or other currency) spent, and in a preferred embodiment one point is earned for each U.S. Dollar spent. Often, a discount will be immediately provided to the customer presenting the identification means.

At other times, a coupon or certificate that is good for later use will be offered to the customer. In a preferred embodiment, when a customer presents a means for identification and a “hard” receipt is provided, the customer will receive additional information and data about the customer's account, such as selected merchant specific and master point balances, for example. In addition, the customer is provided access to a database of participating merchants through a tracking module. Furthermore, it is advantageous to provide the customer modular access to a database that maintains a listing of offers and promotions from merchants.

For merchants, the invention enables the tracking module to create, modify, and track incentives offered to customers. Also, merchants may use the tracking module to track the number of points a customer has, to activate and programs prize promotions, and to schedule promotions for specific periods of time.

Preferably, the invention maintains a database of information, including at least customer information. For example, prior to activation a loyalty system may retrieve personal information, information regarding spending habits, and other related information. The information is then preferably stored in a customer database and used for analysis and segmentation, as described below. In addition, customer information that is related to a single merchant, or a grouping of merchants, can be stored in a customer database.

For segmentation, customers may be segmented into categories, such as an active category, an inactive category, for example, to allow merchants to provide more effect incentives and to target marketing material to particular customers. Such customer segmentation information may include average transaction amount, frequency of visitation to a particular merchant, and age-gender/other demographic information, for example.

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the Claims section.

Description of the Drawings

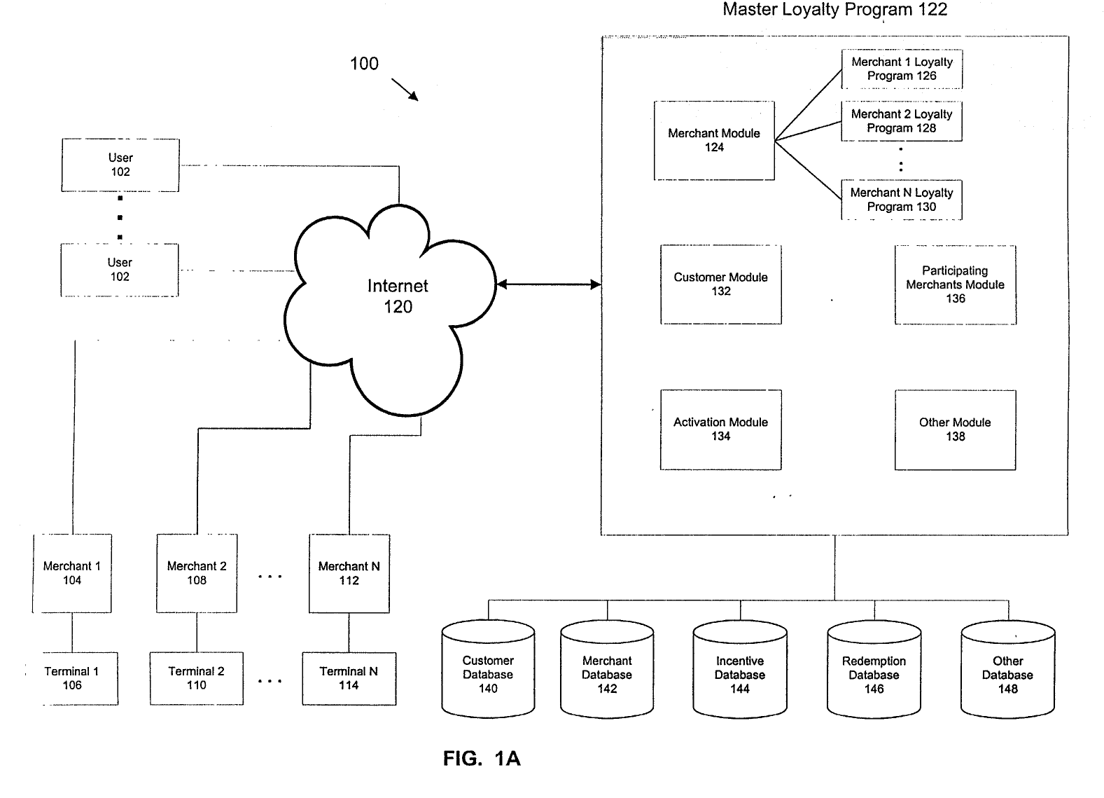

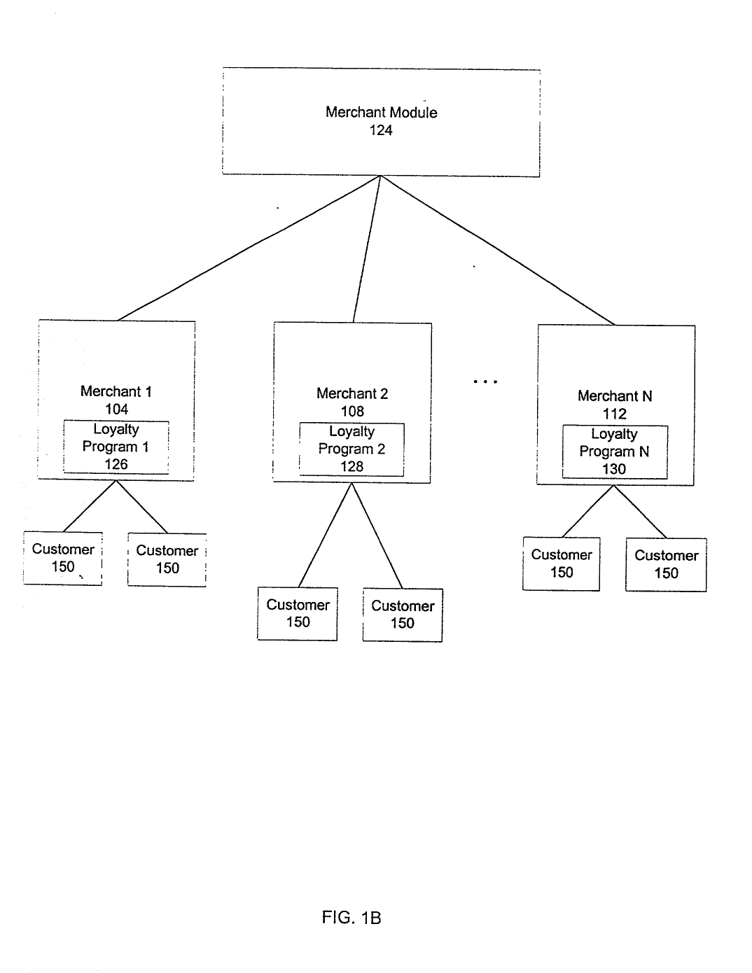

FIG. 1A is a diagram of a multi-merchant loyalty system 100. One or more users 102 may access a Master Loyalty Program 122 via the Internet or other means. One or more merchants 104, 108, 112 may similarly access the Master Loyalty Program 122. A terminal may enable merchants to access the Master Loyalty Program 122 via a merchant location 106, 110, 114.

Each terminal 106, 110, 114 may include a payment card reader for reading a credit card, debit card or a Loyalty Program card, for example. Then the terminal 106, 110, 114 may access the Master Loyalty Program for verification of customer status, to credit a customer account with points, or to provide benefits to the customer. Any points that are awarded are based on parameters selected by a merchant, such as the amount of the purchase, as long as the parameters are within limits set by the Loyalty Program Card. For one embodiment a terminal may have a plurality of readers, with at least one reader being for a payment card and one reader being for a loyalty card. Of course a single reader could provide the ability to read either card type. In another embodiment, no card reader is needed and the customer uses some private identification means, such as a password or a fingerprint.

The Master Loyalty Program 122 may include a merchant module 124. The merchant module 124 may provide and/or maintain a plurality of loyalty programs 126, 128, 130. In addition the Master Loyalty Program 122 may include a customer module 132, an activation module 134, a participating merchants module 136, and various other modules 138.

Participating merchants may have access to a specific merchant loyalty program 126, 128, 130. For example, a first merchant 104 may have access to a first merchant loyalty program 126, whereby the first merchant 104 may track incentives, customer data, and other information. Similarly, a second merchant 108 may have access to a second merchant loyalty program 128, and a merchant “N” 112 may have access to an “Nth” loyalty program 130. Thus, the invention enables a merchant to access, track, alter, delete or perform some other function to a merchant specific loyalty program.

Customer data may be stored in a customer database 140, and customer data may include personal information, address information, spending habit information, or other information. Likewise, merchant data may be stored in a merchant database 142, and may include merchant location, merchant produce/service offerings, and other information. An incentive database 144 may store information regarding incentives offered, incentive templates, and other incentive information. In addition, a redemption database 146 preferably stores tracking information regarding at least customer redemption history. Preferably, the information in the databases enables merchants to market to customers by defining and creating customer segments.

FIG. 1B illustrates another embodiment of a multi-merchant loyalty system. A merchant module 124 may provide merchants the ability to create, implement, and manage a customized incentive program. For example, each merchant may define and select desired incentives to offer customers. A first merchant 104 may use a first loyalty program 126 to offer customers 150 incentives associated with a restaurant. Likewise, a second merchant 108 may offer a second loyalty program 128 to offer shoe-store targeted incentives, such as a percentage off a particular brand of shoes. Other merchants, such as a merchant N 112, may offer incentives that are customized to the particular market the merchant N 112 serves, or may offer incentives that are customized to that merchant N 112.

It should be noted that although each merchant may have a specific and customized loyalty program, each merchant may also choose to participate in a Master Loyalty Program. Accordingly, while a customer receives a point for purchasing or transacting with a merchant, the customer may also accumulate points in the Master Loyalty Program. This provides and enables a “two-tiered” rewards system, which could increase the attractiveness of the rewards system to a consumer, and make the loyalty program less taxing to the consumer since only one identification means is needed.

In a preferred embodiment, a means for identification, such as a program card, is pre-activated, and may be included in a membership kit that outlines features and benefits of participating in the program, participating merchants, incentives offered at varying levels, and how to claim incentives. This could allow a kit to be included in a welcome to the neighborhood kit, or another membership kit for any organization. In addition, it could allow a person to take advantage of being a member of an incentives program with the convenience of signing up for the program at a later time. This is achieved by assigning a unique identification to the means for identification. Then, when a person obtains the means for identification, such as at a point of purchase, the person can immediately use the program benefits. Later, when the person has time, they can sign up for participation in the program via phone, fax, or the Internet, for example, and the person will be associated with the unique identification.

Many alternative embodiments associated with the means for identification are realizable. For example, the means for identification may be delivered through a merchant purchase, a promotion at a merchant location, direct mail, or a website request, for example. In addition, the means for identification is preferably limited to a predetermined number of uses prior to registration, such as one use. It is also desirable to provide the user with periodic updates of information either via email, direct mail, or receipt printout, for example.

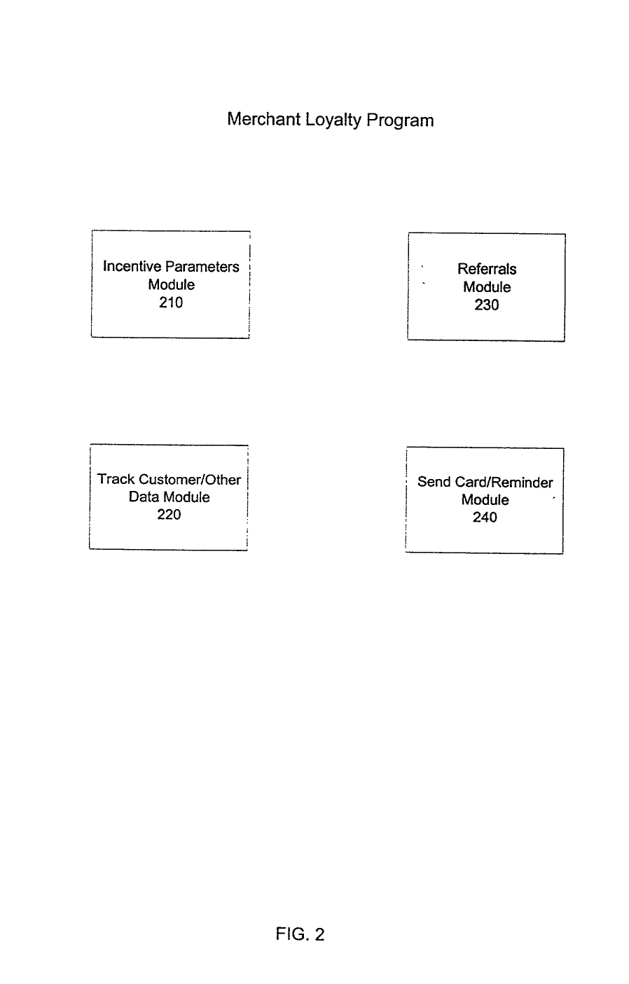

FIG. 2 shows a diagram of a merchant loyalty program for a multi-merchant loyalty system. A merchant loyalty program for a merchant may provide an incentive parameters module 210, a track customer/other database module 220, referrals module 230, and a send card/reminder module 240.

An incentives parameters module 210 gives a merchant the ability to define and customize incentives for individual customers or for customer segments. Incentive parameters may include an incentive type, such as a discount, a coupon, a gift, or an upgrade, for example. In addition, an incentive duration is definable, as is a relationship between a consumer activity and points earned (for example, points given per dollar spent), for example. Such a system would allow a merchant to offer special coupons and savings during seasonal periods, such as Christmas. Furthermore, restrictions and limitations may also be defined.

A track customer/other data module 220 (the tracking module 220) allows a merchant to view various customer data. Exemplary customer data includes activation information, customer activity information, and demographic information. In addition, the tracking module allows for customer segmentation for analysis and targeted incentives. Some merchants may wish to segment based on frequency of customer activity, amount spent by a customer, active customers, or inactive customers, for example.

A referrals module 230 allows merchants to submit referrals, and to register for participation in either or both of the Master Loyalty Program and merchant specific loyalty program. In addition, the referrals module 230 may provide incentives, discounts, or other rewards based on the number of referrals received from a particular merchant or a group of merchants.

A send card/reminder module 240 allows a merchant to send reminders, such as electronic cards, emails, letters, or coupons, for example, to customers. For example, a merchant may send a reminder to a customer on the customer's birthday to build goodwill.

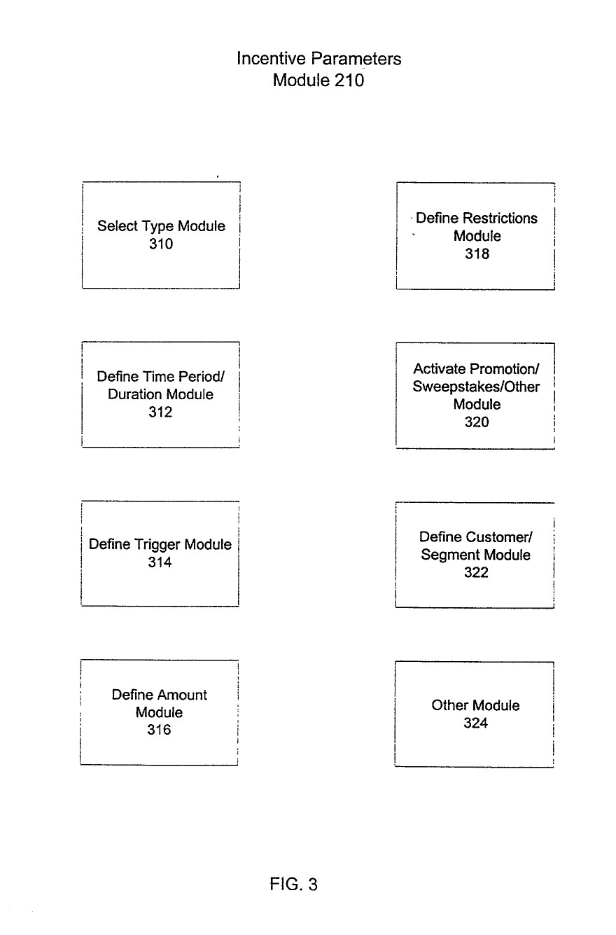

FIG. 3 provides a diagram of an incentive parameters module 210. The incentive parameters module 210 may provide a select type module 310, a define time period/duration module 312, a define trigger module 314, a define amount module 316, a define restrictions module 318, an activate promotion/sweepstakes/other module 320 (the other module 320), and a define customer segments module 322. Other modules may be included and are represented by an other module 324.

A select type module 310 allows a merchant to define an incentive or incentives, or to select one or more of a plurality of predefined incentives. Such incentives include coupons, discounts, free gifts, upgrades, and special treatments, for example. In addition, a merchant may apply different incentives to different market segments. The select module 310 preferably allows a merchant to identify a threshold number of points needed to receive a particular incentive. For example, a merchant may define an incentive as a $30 gift certificate, and require 300 points to earn the gift certificate. It should be noted that a merchant may allocate more points to different items to promote those items.

A Define Time/Duration Module 312 enables a participating merchant to specify a start date and an end date of a given promotion. Other options allow a merchant to specify a start date and an open end date, if an end date is not desired. A merchant may also specify (or select) a duration for a particular promotion, such as 2 months, 6 months, holiday season, or Easter week, for example.

By example, a merchant may define one or more “triggers”, such as an event or customer activity, for example, that may activate a predetermined incentive, as directed by a Define Trigger Module 314. Various triggers may be selected or defined by a merchant to generate customer interest and sales.

Some exemplary triggers include a season (a holiday or time of year), time period, or customer activity, for example. There may be instances where a trigger may be defined to activate a merchant selected incentive. For example, if a customer purchases a particular item the customer may be offered an incentive, such as a coupon, to receive a second item, often specified by the merchant, at a discount.

A particular merchant may define the amount of an incentive with a Define Amount Module 316. The amount of the incentive may be in the form of a dollar amount. For example, a customer may be eligible for a $30 of gift certificate to a participating restaurant, provided that a predetermined number threshold of points are accumulated by the customer. The incentive may be in the form of free merchandise or service. Thus, a customer may receive a coupon for free appetizers, drinks, and/or deserts at a participating restaurant. Also, a customer may receive a coupon for a free pair of shoes with a purchase of a suit from a clothing store. Other incentive amounts may be presented in the form of a percentage, such as 50% off the next purchase.

A Define Restrictions Module 318 may define restrictions. Restrictions may include restrictions on time, or a particular user, for example. Thus, A merchant may place time restrictions on an incentive. For example a merchant may specify, at the time of issuance, that a certificate (or incentive) may not be redeemed until the next day so that the certificate will be applied to the next purchase.

In addition, a restaurant may require a certificate to be valid during slower times, such as weeknights and in non-evening hours. Use restrictions may also be applied. For example, a merchant may require that an incentive may not be combined with other sales, promotions, or other incentives.

A merchant may activate a promotion, sweepstakes or other type of incentive programs with Module 320. Accordingly, a merchant may wish to promote more business during slow business times. A merchant may also partake in a sweepstakes which may involve a drawing where one or more customers may win prizes, cash, or trips, for example. A merchant may also make participation contingent on the amount or frequency of customer spending activity, thereby drawing more predictable customer attention and spending. Furthermore, a merchant may also activate promotions that involve multiple (double, triple, etc.) point days. Accordingly, during designated time periods, customers may receive more points for a given purchase.

A Define Customer/Segment Module 322 allows a participating merchant to determine which customers may receive particular incentives. For example, a merchant may send one or more incentives to all customers, to active customers, to inactive customers, to a particular customer, to a group of customers or other customer segments defined by the merchant. Thus, this feature of the invention enables targeted marketing schemes.

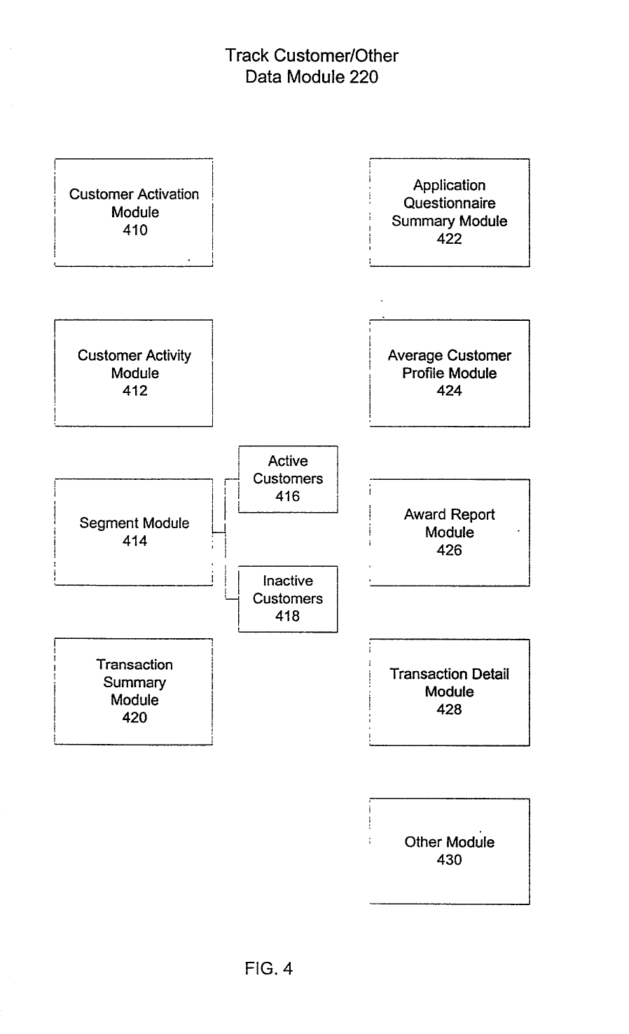

FIG. 4 illustrates a detailed example of Track Customer/Other Data Module 220. The Track Customer/Other Data Module 220 may include one or more of Customer Activation Module 410, Customer Activity Module 412, Segment Module 414, which may include Active Customers 416 and Inactive Customers 418, for example. Also provided by the Track Customer/Other Data Module 220 are a Transaction Summary Module 420, an Application Questionnaire Summary Module 422, an Average Customer Profile Module 424, an Award Report Module 426, and a Transaction Detail Module 428. Other modules and options may also be included, as shown by an Other module 430.

A Customer Activation Module 410 enables a participating merchant to view a report that details customers who have joined a merchant loyalty program. In one embodiment, the module 410 displays those customers who have joined during a predetermined period of time, such as last month, last week, current month to date or other time period. For example, a merchant may view one or more of: the name of the customer, an identification (such as a number), details of the first transaction and other transactions, address information, phone number(s) information, and/or a date of an order, for example.

At Customer Activity Module 412, a participating merchant may view details of customers that have visited the merchant during a predetermined period of time with a summary of the customer activities. For example, summary activity may include a customer name (or other identifier), an account number, a card type, a month-to-date transactions, a month-to-date points, a year-to-date transactions, a year-to-date points, a balance, grand totals, and other information.

A Segment Module 414 enables segmenting of customers based on various factors and characteristics. For example, customers of a participating merchant may be segmented based on spending habits. Thus, a merchant may view a defined top (or bottom) percentage of high spenders, single visit purchases, frequent visits and other types of customers, as active customers 416. For example, a merchant may view the top 10% of customers/program participants who may be defined as high spenders during a time period, such as a month. The merchant may view the one or more customers' names, identification information, address information, phone information, total number of transactions, total dollars spent, average purchase and other information. Another statistic of interest to a merchant is the top 15% of customers with single visit purchases. The merchant may view one or more of customers' names, identification information, address information, phone information, the amount of a single purchase and other information for these purchasers as well.

Furthermore, the merchant may view the top 20% biggest spenders among frequent customers. The merchant may view the one or more customers' names, identification information, address information, phone information, total number of transactions, total dollars spent, average purchase amount and other information. When viewing various forms of customer information, the merchant may also sort by various factors for analysis and comparison. Merchants may use this information to target loyal customers and maintain positive customer relations.

A merchant may also view inactive customers, such as customers who have not purchased from the merchant within a predetermined time period, such as the last 30, 60, or 90 days, via an Incentive Customers module 418. A merchant may view the customers' names, identification information, last day at the merchant's place of business, the time period since the customer's last purchase (or visit), address information, or phone information, for example. The merchant may use this information to target potentially “lost” customers and/or investigate why customer interest has dropped. Other customer segments may be identified and analyzed based on various customer characteristics, spending habits and other factors.

A Transaction Summary Module 420 may be used by merchants to view a summary of all transactions by transaction type. Exemplary transaction types include accruals, redemptions, and bonuses, for example. The data may be limited to data relevant foe a defined time period. For example, a merchant may view transaction description, terminal location, transaction count, average points, total points, average dollars, or total dollars, for example. This module 420 enables merchants to track customer and transaction data for detailed analysis.

An Application Questionnaire Summary Module 422 enables a participating merchant to view statistical information. Typically, the statistical information will be compiled based on answers to various demographic questions as presented on applications for membership to the loyalty program of the present invention. Information may also be gathered from other sources. A merchant may select questions, and then view customer answers to those questions. For example, questions may include data related to how often customers dine out, how many automobiles are owned by the customer, whether the customer owns or rents, and other customer answers to demographic and other questions. This data may be stored and categorized as defined by a merchant for detailed analysis and comparisons which may be used to enhance a merchant's ability to target customers and customize incentives for improved customer interest.

An Average Customer Profile Module 424 enables a participating merchant to view details regarding the merchant's average cardholding customer. Various demographic as well as transaction information may be presented and sorted according to defined specifications. Merchants may use this information to focus attention on a customer group/type or make efforts to expand their clientele.

An Award Report Module 426 may be used to track and organize award transactions and other information. For a participating merchant, this feature of the present invention may provide award summary reports. Thus, a merchant may view and/or manipulate data regarding each incentive issued to a customer. A time period for the report may be identified, such as previous 1 day, previous 2 days, previous 3 days, previous 7 days, previous 30 days, or last month, for example. Information may include certificate (or award) number, account number (or other identifier), customer information, address information, issue date, expiration date, amount of certificate (or award), terminal ID, batch number, or reference number, for example.

A Transaction Detail Module 428 provides details regarding transaction information for a participating merchant, and preferably during a predetermined period of time. A merchant may sort transaction information based on Time Order, Amount Spent, Batch and/or Reference Number, Card Account Number, Clerk and other criteria and/or characteristics. In addition, a merchant may specify time-specific search criteria, such as the previous day, previous 2 days, previous 3 days, previous 7 days, previous 30 days, current month to date, last month, or other time period. Transaction information related to a merchant may include transaction date, transaction time, term information, batch information, clerk information, member information, card type, transaction code, error code, data source, total points, total dollars, and other information, which may be sorted and analyzed by the merchant and other authorized entity.

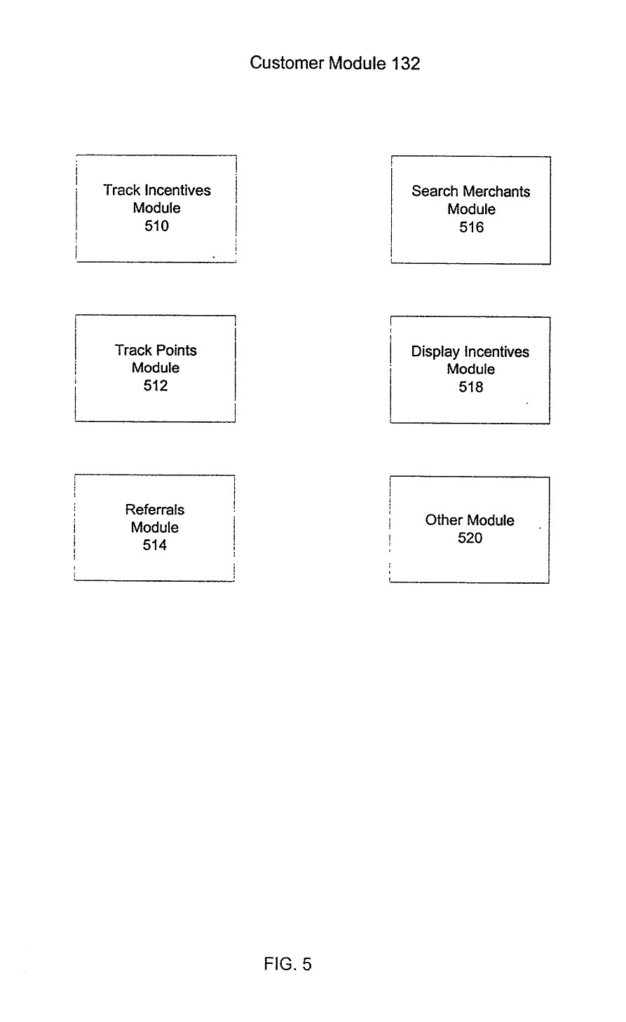

FIG. 5 is an example of details associated with a Customer Module 132. The Customer Module 132 includes one or more of a Track Incentives Module 510, a Track Points Module 512, a Referrals Module 514, a Search Merchants Module 516, or a Display Promotions Module 518. Other modules and options may also be included, as shown by an Other module 520.

The Track Incentive Module 510 enables a customer to view the types, number and details related to the incentives awarded to the customer. If a customer has memberships to more than one merchant, the customer may track and monitor incentives specific to all (or some) merchants as well as incentives of the overall loyalty system. In addition, the customer can view the incentive status and promotional point amounts for any mid-level incentive programs in which points have been earned, or which the user designates that they wish to follow. Characteristics such as type, duration, restrictions and other factors may be viewed and categorized by the customer. The customer may also program or activate incentive updates which may include an email (or other form of communication) to the customer informing the customer of pending incentives. For example, a customer/user may request an update of all pending incentives at participating merchants each week or other defined time period.

A Track Points Module 512 enables a customer to view information related to points for a loyalty system and various merchant specific loyalty systems of which the customer is a member. Information available to the customer may include the total number of points accumulated under the loyalty system, the number of points accumulated under each merchant specific loyalty programs, the number of points redeemed, or the number of points needed to redeem the next incentive, for example.

A Referrals Module 514 enables a customer to submit referral information related to other potential customers. In addition, the loyalty system of the present invention and/or specific merchant loyalty programs may provide incentives or discounts based on the number of referrals received from a customer.

A merchant module 516 allows a customer to enter criteria (or characteristics to search for a participating merchant. For example, a customer may enter data regarding a geographic area of interest, such as a city, state, or zip code, or a category of interest, for example. A category of interest may include: retail, education, goods, services, community service, moving, storage, business, pets, travel, insurance, financial, dining, or other areas of interest. Exemplary merchant related information includes shopping information, hours of operation, phone numbers, maps, directions, menus, reviews, web links, and other information.

A display incentives module 518 presents incentive information, and may provide targeted information to a consumer. The display incentives module 518 may provide information regarding a specific customer, or a specific type of customer, and may allow a merchant to search for customers based on database fields. The display incentives module 518 also allows a customer to view incentives, and information specific to that customer. The information may be viewed by segment type, or other defined criteria. A customer may also search for particular incentives and information by various criteria, such as incentive characteristics.

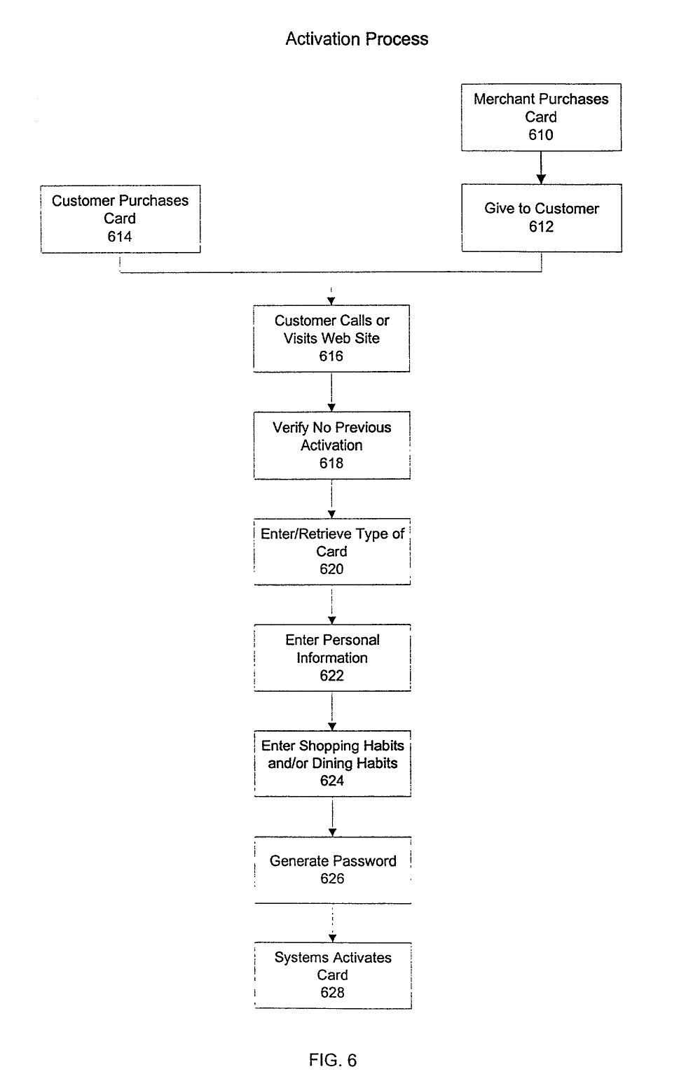

FIG. 6 is a flowchart of selected acts of an activation process 600. At a first act 610, a merchant may purchase a means for identification, such as a loyalty card. The loyalty card is presented to a customer in a second act 612. In a third act 614, the customer may purchase an identification means. Then, the customer will access the Master Loyalty System (the system) via any means, such as a web site, a wireless web, or a phone system for example. At a fourth act 618, the system verifies that the customer is a unique customer (to avoid duplication). Then, in a fifth act 620, the customer identifies the type of identification means desired, which could include selecting a membership level. If an identification means is requested through a merchant, the identification means may be predefined by that merchant.

In a sixth act 622, the system prompts the customer for demographic information, and at a seventh act 624, the customer may be prompted for additional information, such as shopping habits, and dining habits, for example. The customer provided information is preferably stored in databases. Then, the system may generate a password or other security means for the customer at an eighth act 626. Then, in a ninth act 628 the system activates the identification means to that the customer may start using the system, and accumulating points.

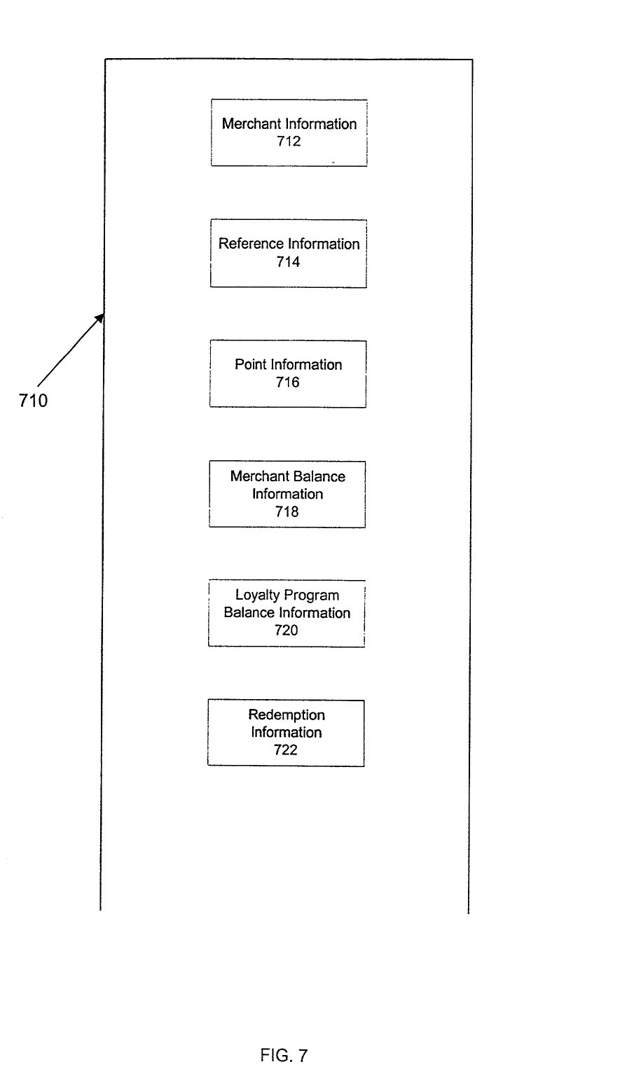

After the system activates the identification means, the customer may receive an updated report, including points, with any receipt. FIG. 7 shows an exemplary receipt 710. The receipt 710 may have a plurality of information, such as merchant information 712, reference information 714, point information 716, merchant balance information 718, loyalty program balance information 720, or redemption information 722, for example.

Merchant information 712 may provide an identification of the merchant, such as the name of the merchant, phone number, fax number, or a personal message from the merchant. Reference information 714 includes a merchant identifier, date, account information, a loyalty program type, a clerk identifier, a purchase amount, and other information. Similarly, point information 716 includes a personal message, total Master Loyalty System points, and total custom merchant loyalty points at 718, and 720.

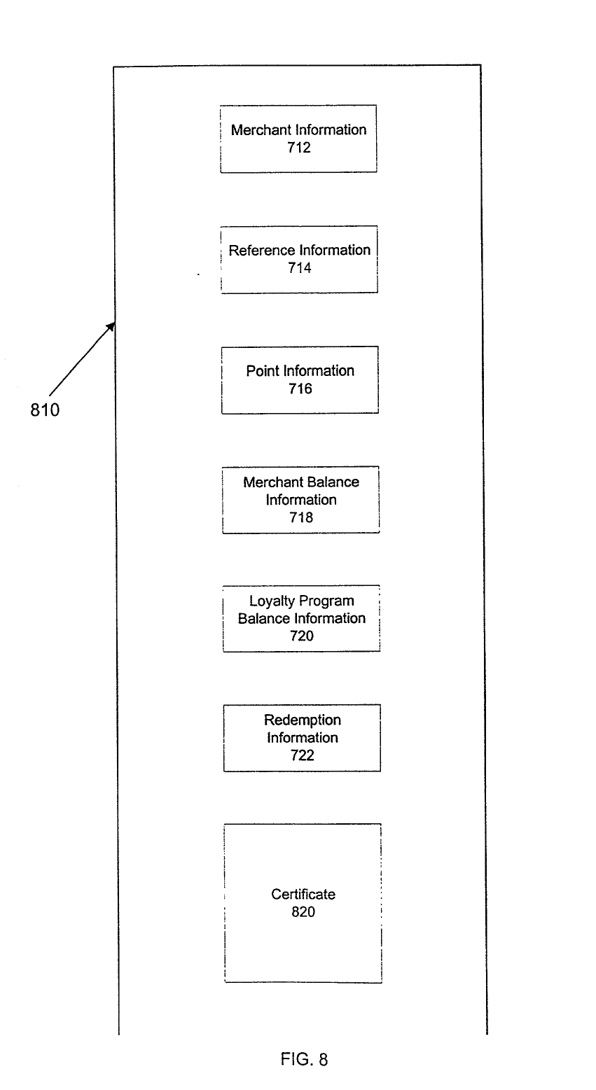

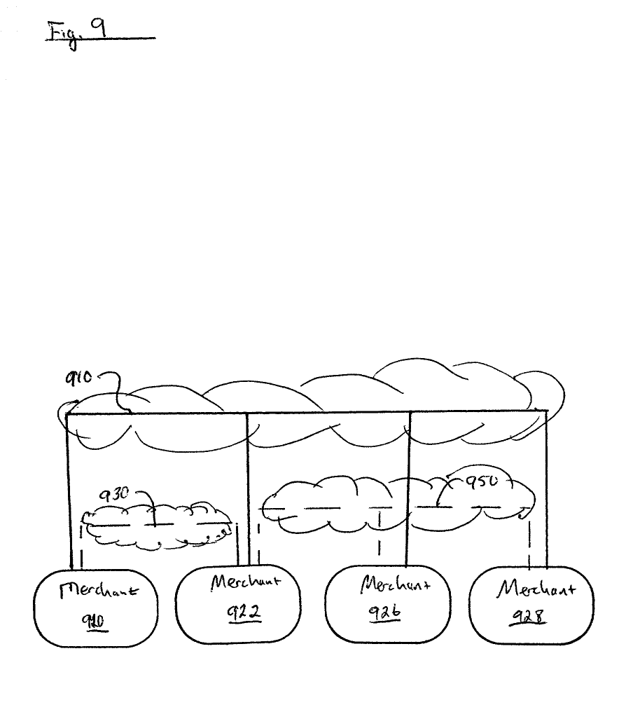

The merchant point balance may be the number of points accumulated for the merchant who just processed the transaction that produced the receipt. A Loyalty Program Balance 720 may display the total number of points the customer has accumulated from all the different participating merchants. Furthermore, redemption information 722 may include information regarding the number of points needed to obtain a “next” or a customer selected incentive. FIG. 8 provides an alternative receipt 810. The receipt 810 preferably provides sections of information, such as merchant information 712, reference information 714, point information 716, redemption information 722, and other information.

Accordingly, when the customer has accumulated enough points for an incentive, an electronic or paper certificate is generated. For example, an instantaneous electronic certificate may reduce a current balance in a merchant account. Also, a certificate may be available for a future date, thereby encouraging a future purchase and patronage. Of course, a receipt 820 may be embodied as a certificate, and may contain any available information about the customer, a merchant, or a loyalty program.

It should be understood that the invention may comprise any number of rewards layers, not just a merchant layer and a “master” layer. Accordingly, FIG. 9 illustrates one exemplary embodiment of the invention having multiple layers of rewards. A Master Reward System 910, and a merchant reward system associated with a merchant, such as a first merchant 920, a second merchant 922, a third merchant 926 or a fourth merchant 928 is disclosed above. However, in the system of FIG. 9, additional layers of reward systems are provided. For example, if the first merchant 920 and the second merchant 922 are Bar-B-Q (BBQ) restaurants, then they may wish to join into a BBQ association having a BBQ layer of rewards 930. Thus, when a consumer purchases BBQ at the first merchant 920, then points are earned in the Master Reward System 910, the first merchant's incentive program, and in the BBQ layer of rewards 930. This could encourage, for example, a BBQ tasting tour for which an incentive, such as a root beer mug, could be given when a customer has visited various BBQ-layer participating merchants.

As another example, all but the first merchants are located in Richardson, Tex. Accordingly, there is a Richardson layer 950 of promotional points awarded. Thus, if a customer transacts business at a sufficient number of merchant locations, or meets some other reward criteria, the customer could be rewarded within that layer of promotion with festival tickets, passes to museums, or other incentives. In addition, points may be transferable between layers, if participants approve. Accordingly, someone on a BBQ tour (layer 930) may be eligible for the museum passes of the Richardson promotion layer 950, or the Master Reward System 910.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A loyalty system for awarding incentives to a customer based on a multi-merchant loyalty system, comprising:
a master loyalty program associated with the multi-merchant loyalty system;
at least one merchant specific loyalty program associated with the multi-merchant loyalty system;
a means for providing a merchant access to the multi-merchant loyalty system; and
a means for providing a customer choice of an incentive.

2. The loyalty system of claim 1 further comprising a means for enabling a customer to track incentives.

3. The loyalty system of claim 1 wherein the means for providing a merchant access is a merchant module.

4. The loyalty system of claim 1 wherein the means for providing a customer choice is a master loyalty module.

5. The loyalty system of claim 2 wherein the means for enabling is a customer module.

6. The loyalty system of claim 1 wherein a merchant may define an incentive parameter for the multi-merchant loyalty system.

7. The loyalty system of claim 6 wherein the incentive parameter comprises a trigger.

8. The loyalty system of claim 6 wherein the incentive parameter comprises a customer segment.

9. The loyalty system of claim 6 further comprising a means for tracking customer data.

10. The loyalty system of claim 1 further comprising a means for generating a certificate when a predetermined parameter is fulfilled.

11. A method for promoting merchant loyalty, comprising:
defining a master loyalty program for a multi-merchant loyalty system;
registering a merchant specific loyalty program for the multi-merchant loyalty system; and
providing a merchant access to the multi-merchant loyalty system.

12. The method of claim 11 further comprising providing data to a customer for enabling the customer to track an amount of points earned.

13. The method of claim 11 further comprising sending a loyalty reward incentive to a customer.

14. The method of claim 13 wherein the loyalty reward is sent electronically to a merchant.

15. The method of claim 13 wherein the loyalty reward is sent electronically to the customer.

16. The method of claim 13 further comprising tracking customer data to create a customer profile.

17. The method of claim 13 further comprising tracking customer data to determine an incentive promotion.

18. The method of claim 11 further comprising registering a merchant for the master loyalty program.
